(19) United States
(12) Patent Application Publication
(10) Pub. No.: US 2018/0101255 A1
(43) Pub. Date: Apr. 12, 2018

(54) Methods for multi-touch ultrasonic touchscreens

(71) Applicant: The Board of Trustees of the Leland Stanford Junior University, Palo Alto, CA (US)

(72) Inventors: Butrus T. Khuri-Yakub, Palo Alto, CA (US); Kamyar Firouzi, Palo Alto, CA (US); Amin Nikoozadeh, San Carlos, CA (US)

(21) Appl. No.: 15/729,341

(22) Filed: Oct. 10, 2017

Related U.S. Application Data
(60) Provisional application No. 62/407,309, filed on Oct. 12, 2016.

(51) Int. Cl. G06F 3/043

(52) U.S. Cl. CPC G06F 3/043; G06F 2203/04104

(57) ABSTRACT

A method of multi-touch detection on a touchscreen by imparting Lamb waves inside a touchscreen, using a first ultrasound transducer having a polarization direction positioned to excite lowest order symmetric Lamb waves (S0), detecting the S0 Lamb waves, using a second ultrasound transducer, where the transducers are connected to the touchscreen, controlling the transducers to selectively and repeatedly pulse the output S0 Lamb waves output to propagate the S0 Lamb waves inside the touchscreen and reflect from each edge of the touchscreen to form a base signal distribution of S0 reverberant Lamb waves across the touchscreen, where a single or a multi-touch perturbation in the reverberant Lamb waves absorbs a portion of the base signal, where the absorption forms an alteration in the base signal and is seen as a signal variation by the controller when received by the second ultrasound transducer, where the controller identifies and locates the perturbation.

### CROSS-REFERENCE TO RELATED APPLICATIONS

This application claims priority from U.S. Provisional Patent Application 62/407,309 filed Oct. 12, 2016, which is incorporated herein by reference.

### FIELD OF THE INVENTION

The invention relates generally to touchscreen. More specifically, the invention relates to multi-touch detection and localization on touchscreens.

### BACKGROUND OF THE INVENTION

Touchscreen sensors are widely used in many devices such as smart phones, tablets, laptops, etc. There are many different types of modalities that enable sensing the touch. The dominant technologies on the market are the capacitive, resistive, acoustic or ultrasound, and optical touch systems. None of these technologies are perfect and each to has some advantages and disadvantages. Overall, the main difficulties of the current touch technologies are the cost of manufacturing, complexity of the hardware/software, power consumption, and multi-touch capability. These have tremendously impeded their widespread applications for large screens.

Capacitive touch technologies are the most common in the industry. However, they suffer from hardware complexity, high manufacturing cost, and high power consumption. They may cause problems by affecting other functionalities of the device in which they are installed, such as reducing the optical performance and transparency of the screen, and introducing cross-talks with other electronics in the device. They work based upon conductivity of the touch object; so, any nonconductive object cannot be sensed. The main stream ultrasound touch technologies are surface acoustic waves (SAW), acoustic pulse recognition (APR), and dispersive signal technology (DST). The main advantages they offer are simplicity in hardware and low manufacturing cost. They operate based on utilizing surface acoustic (SAW) or bending waves (APR and DST). Despite the advantages, they share less than 1% of the market. Surface acoustic waves are highly leaky (into the adjacent medium) or highly attenuating along the path of propagation, thus making SAW technologies extremely sensitive to any surface contamination. Bending wave technologies are more robust. However, they require a tap, thus a high activation force, to produce enough bending waves to be detected. Overall, ultrasound technologies mainly suffer from lacking robustness (i.e., sensitivity to environmental, mechanical, and thermal noise), multi-touch capability, and smooth touch response, making them uncompetitive to analog resistive and capacitive ones.

Surface acoustic waves and bending waves are subclasses of a larger group of guided waves called Lamb Waves. Among academic literature, transient Lamb waves induced by finite piezoelectric transducers have been previously attempted in ultrasonic touch systems, where a tactile object is localized through its interaction with Lamb waves. These involve the interaction of a tactile object such as a human finger with the waves in a solid substrate in either passive or active forms. In active designs, the finger acts as an object perturbing the wave field (for example SAW) whereas in the passive one the touch object acts as the source of the wave field (for example APR and DST). The key advantage of the active designs is that they typically have much higher touch sensitivity and smooth response. The other major difference between these proposals is in the localization algorithm. Despite the differences, they all suffer from lack of robustness and multi-touch capability.

What is needed is an ultrasonic touchscreen system that utilizes interaction of transient Lamb waves with the objects touching the screen.

### SUMMARY OF THE INVENTION

To address the needs in the art, a method of multi-touch detection implemented on a touchscreen device is provided that includes imparting Lamb waves inside a touchscreen, using a first ultrasound transducer, where a polarization direction of the first ultrasound transducer is positioned to excite lowest order symmetric Lamb waves (S0), detecting the S0 Lamb waves, using a second ultrasound transducer, where the first ultrasound transducer and the second transducer are connected to the touchscreen, controlling the first ultrasound transducer and the second ultrasound transducer, using a controller, to selectively and repeatedly pulse the S0 Lamb waves output from the first ultrasound transducer to propagate the S0 Lamb waves inside the touchscreen and reflect from each edge of the touchscreen, where the reflecting S0 Lamb waves form a base signal distribution of S0 reverberant Lamb waves across the touchscreen, where a single touch perturbation or a multi-touch perturbation in the base signal distribution of S0 reverberant Lamb waves absorbs a portion of the base signal distribution of S0 reverberant Lamb waves, where the absorption forms an alteration in the base signal distribution of S0 reverberant Lamb waves, where the alteration is seen as a signal variation by the controller when received by the second ultrasound transducer, where the controller identifies and locates the multi-touch perturbation.

According to one aspect of the invention, different signal signatures induced on the base signal distribution of S0 reverberant Lamb waves correspond to different positions of the multi-touches, a number of the multi-touches, and contact areas of the multi-touches, where each signal signature is output as a distinct signal signature by the controller.

In another aspect, the invention further includes a training step, where for the first ultrasound transducer and the second ultrasound transducer, the touchscreen is touched using an ultrasound-absorptive phantom over a set of points arranged over a rectangular grid on the touchscreen, where corresponding signals are acquired and stored in a memory storage device. In one aspect, the single touch perturbation or the multi-touch perturbation are registered by the controller as column vectors stacked together in a data space Nₜ×N_{c} matrix M, where Nₜ is the number of acquired time samples and N_{c} is the number of touch perturbation points, where corresponding training waveforms construct a touch perturbation set. In another aspect, the data space is reformulated to an image space by the controller, where a localization problem in the data space is transformed to a minimization problem in the image space, where solving the minimization problem in the image space includes solving an unconstrained least squares problem in the data space and solving a constrained least squares problem in the image space.

In a further aspect of the invention, a polarization of the ultrasound transducer includes a metallization that is parallel to the touchscreen edge.

### BRIEF DESCRIPTION OF THE DRAWINGS

FIG. 1 shows a flow diagram of the method of detecting multi-touch events on a touchscreen, according to one embodiment of the invention.

FIG. 2 shows dispersion curves of a 830 μm thick glass plate representing the lowest order Lamb modes and the desired frequency range frequency vs. phase-velocity, according to one embodiment of the invention.

FIGS. 3A-3C show Lamb waves induced by the S0 transducer. The colormap scale is in dB and visualizes the amplitude of the displacement vector field. (a) and (b) show the propagation at t=19 _s with and without a touch object. (c) illustrates the registered voltages. solid line with not touch object. dashed with a touch object in the middle of the screen, according to one embodiment of the invention.

FIGS. 4A-4I show a time sequence of reflecting S0 Lamb waves from approximately 12 μsec-1 sec., according to one embodiment of the invention.

FIG. 5 shows a S0 bonding configuration, realized by attaching the longitudinal transducer to the edge of the screen, according to one embodiment of the invention.

FIG. 6 shows an in-lab implementation of the explained procedure that was used in the experimental setup, according to one embodiment of the invention.

FIGS. 7A-7B show the performance of an eleven-touch test from the image space algorithm, according to one embodiment of the current invention.

### DETAILED DESCRIPTION

The current invention includes design, analysis, and implementation of an ultrasonic touchscreen system that utilizes interaction of transient Lamb waves with objects in contact with the screen. It improves on the existing ultrasound technologies, with the by addressing some of the weaknesses of the dominant technologies that include the capacitive or resistive ones. Compared to existing ultrasonic modalities, among other advantages, the current invention provides the capability of detecting several simultaneous touch points, and also a more robust performance. Furthermore, it demands much less hardware complexity resulting in higher yield, less manufacturing cost, and less operating power consumption. It is sensitive to any touch object that can reflect or absorb sound waves such as a finger, gloved finger, pen, etc. It is flexible to support a wide range of screen sizes, from a watch to a projection screen. It works based on sensing the interaction of ultrasound wave fields with the touch objects. For the current invention, presented herein are localization algorithms that can detect several touch points with a very limited number of measurements (one or two). This in turn significantly reduces the manufacturing cost.

Further, the current invention provides a learning (training) based technique to localize the touch contacts. Other training or learning methods have been previously applied in different contexts such as localization and classification of defects and flaws in solid substrates and localization of tactile objects in contact with a plate. In such methods, generally the system is looked at as a black box and any (a posteriori) measured data is matched with a set of a priori measured data. They are advantageous in localization problems where the wavefield is seemingly random, chaotic, and thus, extremely complicated, such as the wave propagation in a reverberant or highly heterogeneous domain.

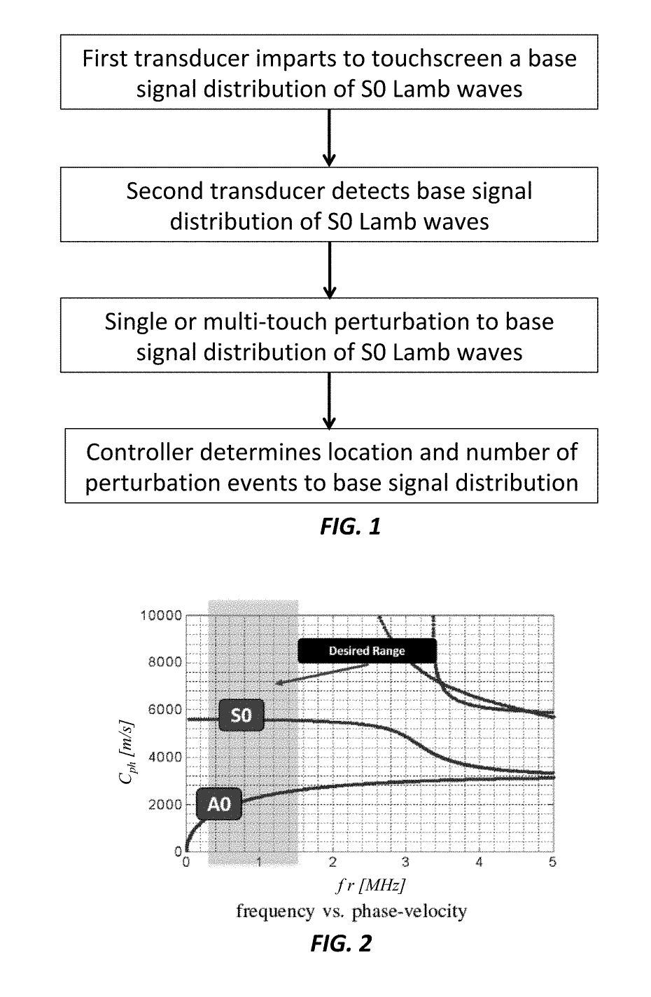

FIG. 1 shows a flow diagram of the method of detecting multi-touch events on a touch screen that includes imparting Lamb waves inside a touchscreen, using a first ultrasound transducer, where a polarization direction of the first ultrasound transducer is positioned to excite lowest order symmetric Lamb waves (S0), detecting the S0 Lamb waves, using a second ultrasound transducer, where the first ultrasound transducer and the second transducer are connected to the touchscreen, controlling the first ultrasound transducer and the second ultrasound transducer, using a controller, to selectively and repeatedly pulse the S0 Lamb waves output from the first ultrasound transducer to propagate the S0 Lamb waves inside the touchscreen and reflect from each edge of the touchscreen, where the reflecting S0 Lamb waves form a base signal distribution of S0 reverberant Lamb waves across the touchscreen, where a single touch perturbation or a multi-touch perturbation in the base signal distribution of S0 reverberant Lamb waves absorbs a portion of the base signal distribution of S0 reverberant Lamb waves, where the absorption forms an alteration in the base signal distribution of S0 reverberant Lamb waves, where the alteration is seen as a signal variation by the controller when received by the second ultrasound transducer, where the controller identifies and locates the multi-touch perturbation.

Turning not to the governing physics of the invention, the basic governing principle revolves around the propagation of guided elastic waves in a bounded space such as a touchscreen plate (e.g., a glass screen). One feature it heavily relies on is the propagation of Lamb waves in the screen and their leakage upon interfacing with a field-perturbing object (such as a human finger). The second feature is the longtime behavior of the Lamb waves inside a bounded domain, which is reminiscent of a reverberant field and transient wave chaos. The current invention utilizes the time evolution of the high frequency modes of a bounded elastic structure.

Lamb waves are guided elastic waves that propagate in thin elastic media. Lamb waves are multi-mode and dispersive with a very complicated nature. Dispersion results in several orthogonal modes. They are classified based on the symmetry of the mode-shapes into symmetric (S) and asymmetric (A) modes. The characteristics of Lamb waves in a plate are a function of the thickness, Young's modulus, Poisson ratio, and frequency. The dispersion curves of a 830 μm thick glass screen representing the lowest order Lamb modes and the desired frequency range are plotted in FIG. 2. The corresponding mechanical properties are given in TABLE 1.

TABLE I
Mechanical properties of glass.

| Parameter | Description | Value | Unit |
|---|---|---|---|
| E | Young's Modulus | 74 | GPa |
| ν | Poisson Ratio | 0.23 | — |
| ρ | Density | 2480 | kg/m³ |

The lowest order symmetric and asymmetric modes are generally abbreviated as, respectively, the S0 and A0 modes. They have unique properties that make them ideal for applications such as nondestructive monitoring of solid substrates. Among these properties, the most useful one is the fact that they exist in the entire frequency spectrum, whereas higher order modes have certain frequency cutoffs, below which they cannot exist. This makes them ideal when the application is limited to a bandwidth below the cutoff frequencies of the higher order modes, as there would be no mode conversion into other modes. This in turn reduces the complications arising from significant dispersion related effects that occur upon utilizing higher order modes. Furthermore, the dispersive behaviors of these modes are well-tolerable compared to the higher order ones; in particular, in low frequencies, the S0 mode is almost non-dispersive and the A0 mode very well matches the behavior that is predictable using simple reduced order models such as the classical plate theory. Also, as one goes lower in frequency, the phase velocities of the S0 and A0 modes separate more; hence, the wave-packets generally can be separated and analyzed more easily and accurately. A0 and S0 modes at the lower end of the spectrum are also much less lossy and more scratch resistant compared to the higher end of the spectrum (i.e., Rayleigh waves).

In many practical applications, it is favorable to selectively excite the Lamb modes. This can, however, be very challenging, and in this regard, upon isolating the frequency band, the A0 and S0 modes can be robustly and selectively excited using a proper transducer design. Because of these reasons, the A0 and S0 modes at the lower end of the spectrum are more favorable than the other modes and the higher end of the spectrum for the touch-sensing mechanism. Lamb waves propagating adjacent to a fluid can leak depending on the velocity of propagation relative to the surrounding medium. These waves are called leaky Lamb waves (also called generalized Lamb waves). They are much more complicated in behavior. A human finger to ultrasound waves at around a MHz frequency regime appears as a compressible fluid with negligible shear effects and with a speed of sound at about 1500 m/s, which can in turn lead to the leakage of the Lamb waves into the finger. A glass plate and human finger have a significant impedance mismatch with air. Lamb waves can also leak into air, however, with much less efficiency. This principle makes a human finger (or any object with a close acoustic impedance) create a much more pronounced effect on the Lamb waves compared to the surrounding environment such as air. This property lays out a key feature for a human touch to perturb the Lamb waves upon interfacing with the glass screen.

Wave propagation in enclosures can lead to mixing of the wave energy, ultimately leading to an incoherent spreading of information. This is the manifestation of a reverberant field, which makes the localization problem very challenging. Reverberant fields in enclosures can potentially carry useful information, however, in an incoherent way. Incoherency comes from consecutive reflections of the wave energy several times in the domain. This along with diffraction and dispersion effects can ultimately lead to mixing of the wave energy in a seemingly random way. However, spreading of the wave energy in a reverberant field can lead to multiple interrogations of each point in the enclosure. This suggests that, upon registering a longtime response of the system at only a few locations in the domain, any substructural changes in the enclosure can be sensed with sufficient information carried by the wave energy flow. The Lamb wave touchscreen attempts to reconcile these key features of the reverberant field with the benefits of the lowest order Lamb modes. This, thus, motivates a system that includes small transducers integrated with a plate. The transducers are pulsed selectively and repeatedly to create propagating Lamb waves inside the plate. The field is then measured at a selection of the transducers (which can include the transmitters as well). Upon having a touch, a local perturbation is created at the touched region, and hence, a portion of the wave field is absorbed through the touch(es). This absorption alters the base signals (i.e., the signals measured when there is no touch) in many ways such as by reducing the energy, introducing phase-shifts, etc. Corresponding to different positions of touches, number of touches, and contact areas, different signatures are induced on the base signal, making a touch configuration distinct from other possible touch configurations. As a result of a large number of reflections from the boundaries of the plate, after a while the whole screen is interrogated several times by the waves. This implies every point of the plate is met by the waves multiple times so that a touch is guaranteed to have affected the wave field in a unique way. Furthermore, since the geometry is bounded, no information can escape from the domain. Thus, all the information will be preserved and accessible through measurements at the edges leading to the main hypothesis that sufficient information of the perturbed field can ultimately be registered at a few fixed locations in or at the boundaries of the plate. Disclosed herein are localization schemes that benefit from the reverberant field and can reduce the required number of spatial measurements.

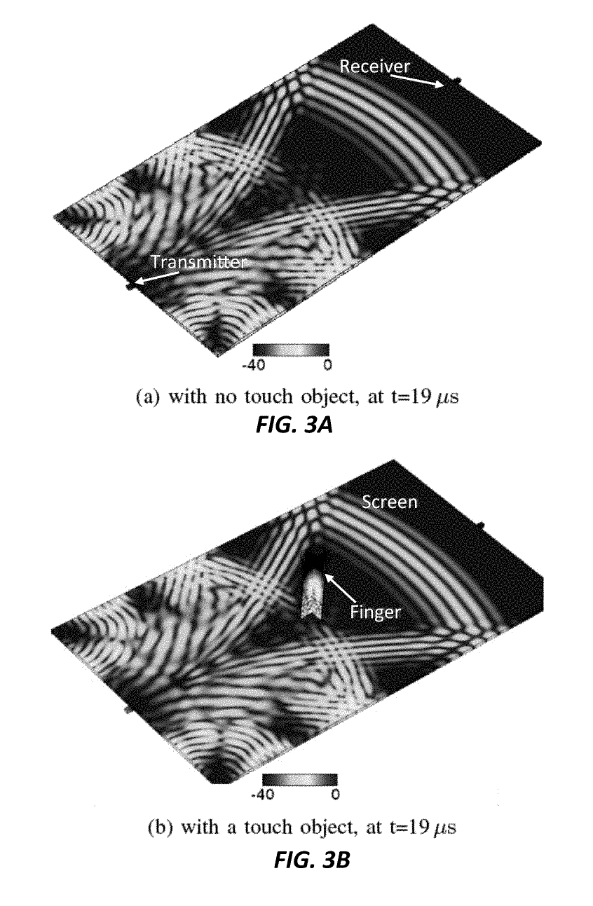

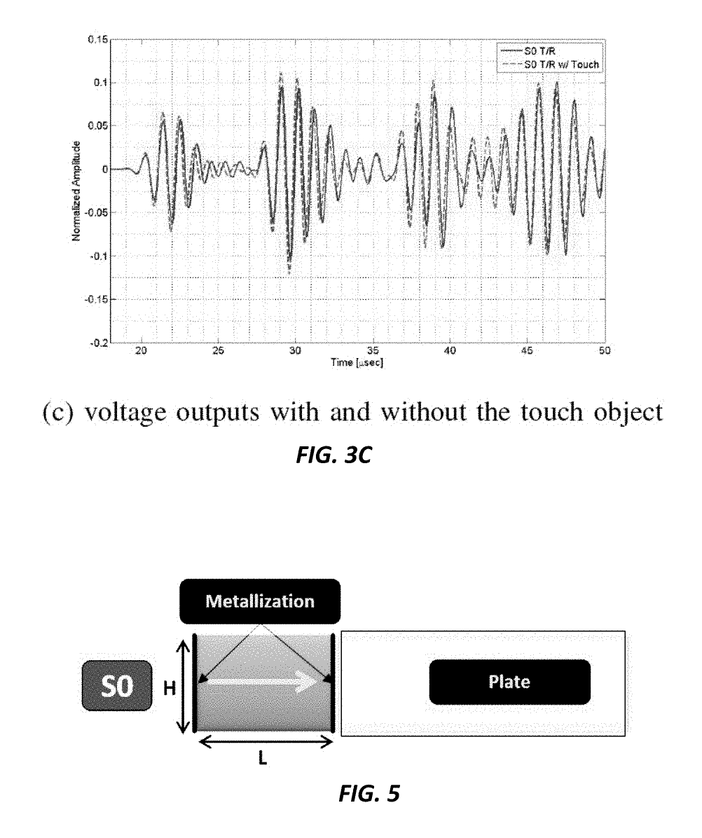

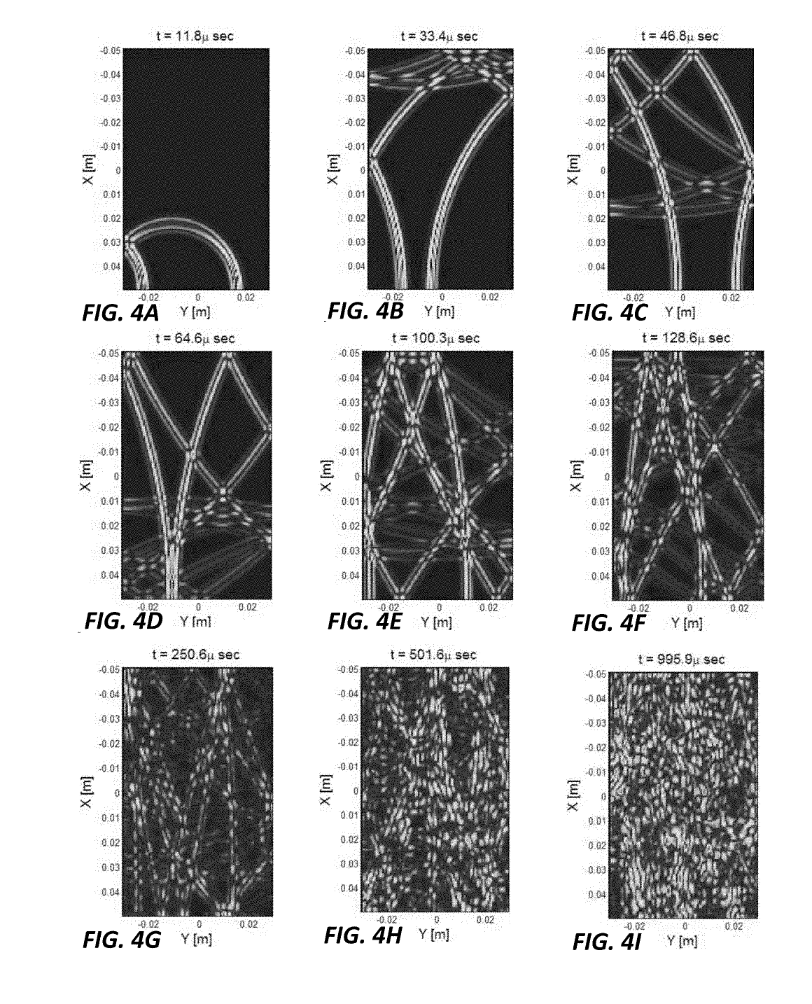

To demonstrate these aspects, a full three-dimensional finite element model was implemented that show the mechanism of the current touch system for a 100 mm×60 mm×0.83 mm screen (see FIGS. 3A-3C). FIGS. 4A-4I show a time sequence of reflecting S0 Lamb waves from approximately 12 μsec-1 sec., where the final frame in FIG. 4I shows a base signal distribution of S0 reverberant Lamb waves across the touchscreen.

Regarding A0 vs. S0 modes for localization, through studying the forward physics of the system, it became apparent that since the A0 mode has considerably more out of plane displacement than S0 mode, it has much more touch sensitivity, i.e., a touch contact leaks around 50% of the A0 wave energy compared to around 5% leakage of the S0 mode. Furthermore, it is slower than the S0 mode, and this provides a shorter wavelength, and thus a better diffraction limited resolution. This makes this mode ideal for conventional imaging techniques such as the tomographic approach. For the problem in hand, sustaining the field reverberations for a long time-window is key. Therefore, it is desired to have a gentle touch sensitivity in order to ensure that the touch moderately leaks the wave energy and in longtime. Moreover, the S0 mode is faster, and hence, has the potential of setting up the reverberant field faster. These, thus, suggest utilizing the S0 mode for localization.

For prototyping, a 20 in×12 in 830 μm thick glass plate, as a standard component in manufacturing of tablets, was used. The touch system includes small piezoelectric transducers glued to the glass plate, such as on an edge, top, or bottom surface. An ideal transducer model is a one-dimensional piezoelectric element of a finite thickness (and infinitely thick in the other directions), with two opposing surfaces metalized in order to provide (a) electrical outputs and (b) a desired electrical field inside the material. In practice, the alignment between the polarization direction and the metalization surface determines the mode of operation of a specific design. A fundamental arrangement for exciting longitudinal motions adjacent to media in the front or back is realized when the polarization vector is aligned with the electric field.

Piezoelectric materials generally have higher nominal acoustic impedances with respect to glass. The nominal acoustic impedance is defined as the product of the nominal speed of sound and the mass density. This suggests that they are the most efficient as half-wavelength resonators. Thus, the principle dimension L is chosen to aim for a half-wavelength resonator at the resonance frequency fₒ, resulting in

$$\begin{matrix}L = \frac{{υ}_{p}}{2 {f}_{o}} , {υ}_{p} = \sqrt{\frac{{C}^{D}}{ρ}} , & ( 1 ) \\ {C}_{33}^{D} = {C}_{33}^{E} ( 1 + {K}^{2} ) , {K}^{2} = \frac{{e}_{33}^{2}}{{C}_{33}^{E} {ϵ}_{33}} . & ( 2 )\end{matrix}$$

C₃₃^{E}, e₃₃, and e₃₃ of the corresponding components of the elasticity, coupling matrix, and permittivity matrices, all represented in the Voigt notation. ρ is the mass density.

The coupling efficiency of a piezoelectric material is generally characterized by a coupling coefficient known as k_{T}². It quantifies the efficiency of a piezoelectric material in converting the electrical energy to the mechanical energy, and vice versa. It is a function of the critical parameters and given as

$${k}_{T}^{2} = \frac{{K}^{2}}{1 + {K}^{2}} . \qquad ( 3 )$$

PZT-5H is among the most efficient piezoelectric materials with k_{T}≈0:5. This gives C₃₃^{D}=157 GPa (vₚ=4575 m/s).

The above-mentioned design assumes that the piezoelectric transducer is infinite in the lateral directions. The real-world transducers are, however, finite in size. Even though, according to the procedure above, they can be designed to achieve a desired thickness-mode performance, the coupling of the lateral modes arising from their finite dimensions in the directions other than the principle one can have dramatically spurious effects on the desired performance. The exact resonance frequencies of these modes are difficult to predict using the full piezoelectric theory due to the complex coupling of the elastic properties. Nevertheless, the in-plane lateral dimension H is chosen such that the coupling of the lateral mode to the principle mode is minimized. This theory assumes that only two coupled thickness-mode resonances exist and the other modes are neglected. This in turn results in a bi-quadratic relation between the two modes characterized by a coupling coefficient. In the case of PZT-5H, for the aspect ratio G=H=L<0.6, the mode separation is large enough to have a safe single mode operation.

This leads to the choice of G≈0.5.

The bandwidth of a piezoelectric transducer, to a large extent, is determined by the medium in the back and front mechanical ports. Considering an air-backed design bonded to a glass plate, with around a 3:1 impedance mismatch at the front port, would provide around a 35% bandwidth. This suffices to limit the performance below the cut-offs of the higher Lamb modes for the present glass prototype; however, it is wide enough to register an enough bandwidth of information for the localization purpose.

The out-of-plane lateral dimension dictates the diffraction effects. It is thus kept at around the plate thickness to (a) achieve a uniform directivity pattern and (b) minimize the coupling of the corresponding lateral mode. Finally, the bonding configuration of the longitudinal transducer will be the determining factor in the selective excitation of the S0 mode. One embodiment of a proper S0 configuration is schematically shown in FIG. 5, according to the current invention.

Following the considerations above, the exemplary designed transducers are 1.66 mm×1 mm×0.83 mm PZT-5H cuboid elements, with 1.66 mm being the dimension governing the ideal thickness-mode resonance. They have the ideal resonance frequencies at 1.38 MHz, with around a 35% bandwidth. This design will lead to the predominant propagation of S0 waves with a typical wavelength around 4 mm.

The prototyping process includes the following steps:

(1) Polishing the glass plate: In this process, the circumference of the plate is ground and polished to ensure the edges are flat. This is essential for a proper contact condition after the PZT-5H transducers are bonded.

(2) Metallization: The edges of the glass plate are metalized using Cr and Au. This provides the ground shared by all of the PZT-5H transducers. After the transducers are diced to the desired dimensions, they are metalized on two of the faces with Cr and Au (Au over a Cr adhesion layer). One shares the ground (and will be glued to the plate) and the other is connected to an electrical connector, through which the response is measured.

(3) Bonding process: The PZT-5H transducers are bonded to the plate using a low viscosity epoxy mixture (HYSOL RE2039+HD3561). For this, the metalized PZT-5H crystals are polished down to match the thickness of the plate and the plate is sandwiched between two slabs of UHMWPE (Ultra High Molecular Weight Poly Ethylene), which provide for accurate alignment. The transducers are then pushed down toward the edge of the plate by a rod and a weight to glue. The bonding is left at the room temperature for 24 hours to cure. This bonding process results in a very thin bond line (less than 1 μm thick) where there is enough metal to metal contact between the transducers metal electrode and the Cr/Au metalization on the edge of the glass plate to make a good electrical connection between the two faces. The process should be repeated for each transducer.

(4) Assembling process: The plate (with the PZT-5H crystals attached to it) is sandwiched at each corner between two rubber washers with a thin sleeve of Teflon in between them to protect the edges of the glass plate from making contact with the metal studs which support them. This mounting arrangement is also for protecting the contact metallization around the perimeter of the glass plate. The whole setup is then mounted on the aluminum standoffs provided by the housing. The glass plate is floating at a fixed distance above the aluminum backing plate. The backing plate is covered with a machined square grid pattern, which aids in the positioning of the finger(s) during testing. The aluminum backing plate also serves as a limiter to protect the glass from breaking in case the glass plate is pushed down with excessive force during testing. The distance between the glass and the aluminum backing plate was arrived at by determining the amount of bow the glass plate could tolerate safely without breaking.

(5) Electrical connection: The metalized face of each PZT-5H (the one that is not bonded to the plate) is connected to the connectors (SMA or BNC) using Tin Plated Copper wires, which are bonded to the PZT-5H transducers using silver epoxy. Similarly, the ground is provided by bonding the wires to the metalized face of the plate.

The system was implemented using a National Instrument™ NI-PXI5024 digitizer. In order to test the hardware, a function generator was used to pulse the traducers, with a 10 V square pulse with a 630 nsec pulse-width. The main lobe of this pulse is band-limited below 2 MHz to assure negligible excitation of the higher order modes. The transducer design as explained in the previous section assures a dominant excitation of the S0 waves. There could, however, be a small contribution of A0 waves, coming from slight coupling of the lateral mode of the transducers and mode-conversion at the boundaries. The responses are then measured at the other transducers. In order to register the responses, a customized acquisition program was developed in the National Instrument LabVIEW™ 2012 programming environment. Registered signals at a receiver on one edge in response to a source at the opposite edge were implemented, without any touch object and with a human finger in the middle of the screen, confirming the system is functional.

Some of the expected wave features were observed; namely, the sound is diffusive in a longtime scale (at about 2 msec), with high frequency oscillations at around 1 μsec. As was shown, a human touch perturbs the registered wave field weakly and randomly at different times. The other feature is the bandwidth of the response which is about 35% and limited by −50 dB below the cut-off frequencies of the higher order Lamb modes (below 2 MHz for the present glass prototype).

The acquisition rate depends on the amount of time-data that must be acquired, which in-turn depends on the reverberant time and how much of which is deemed adequate for the localization. For the present prototype, a 2 msec time-window of data and about 8 msec processing time based on the algorithm to be presented in the subsequent section lead to a 100 Hz acquisition rate.

The invention further includes a learning (training) method to localize the touch contacts. The learning method provides a black-box treatment of the system, implying that the entire algorithm can be implemented experimentally. The learning method, upon an experimental implementation, includes two steps (i) Training step: The screen is touched at selective points with controlled uniform contact areas. The corresponding measurements to each test along with the waveforms of the no-touch condition are stored in the memory. (ii) Localization step: Upon having a touch, the measured data at each receiver is matched with the training set that corresponds to the same transducer.

Turning now to the training step, for a given transmit-receive pair, the screen is touched using an ultrasound-absorptive phantom (i.e., a material with an acoustic impedance close to that of a touch object such as a human finger) over a set of points arranged over a rectangular grid. A suitable material for this purpose is Sylgard-160™ with a 1.6 MRayls impedance close to that of soft tissues. It is cast as a cylinder with a slightly curved end to assure a proper contact radius around 4-5 mm once placed on the screen, upon a 1-2 N force. The corresponding signals are acquired and stored in a hard-drive. The size of the phantom as well as the system parameters such as the sampling rate, number of acquired samples, and spacing between the training points depend on the size of the screen, frequency content of the input, accuracy and resolution of interest. After storing the raw signal, several processing techniques are performed including, but not limited to, filtering. The training waveforms as column vectors are stacked together in a Nₜ×N_{c} matrix M, where Nₜ is the number of acquired time samples and N_{c} is the number of training points (i.e., spatial samples). The training waveforms construct a training set.

Regarding the localization step, upon having a touch interaction, the measured signal at the receiver undergoes a similar signal processing to that of the training set. The measured signals are then corrected for the drift and noise of the system. The intuitive idea behind the learning approach emanates from projecting the touch contact absorptivity or reflectivity Σ(x) over a finite basis set of simple functions; that is, suppose

$${\sum }^{ } ( x ) \approx {\sum }_{i = 1}^{{N}_{c}} {θ}_{i} {χ}_{{x}_{i}} ( x , {a}_{i} ) , {θ}_{i} ∈ ℝ , \qquad ( 4 )$$

where χₓᵢ(x, aᵢ) is an indicator function centered at xᵢ with |supp χₓᵢ(x, aᵢ)|≈aᵢ², i.e., the induced absorption or reflection by a collection of objects can be constructed by summing over the induced effect of some reference objects. Nc is a suitably chosen number. It can then be shown that

$$δ d \approx {\sum }_{i = 1}^{{N}_{c}} {θ}_{i} δ {d}_{i} , \qquad ( 5 )$$

where δdᵢ is the system response to the χₓᵢ(x, aᵢ) as a touch contact and δd is the system response to the total touch function Σ(x). This implies the measured data due to the presence of an unknown object can be considered as a linear combination of a set of measurements corresponding to prior locations of objects and with the same projection coefficients. The resolution of such an approximation obviously depends upon how well the parameter functions can be approximated by the assumed set of simple functions. Ideally, the training touch contacts should have a finer resolution (i.e., smaller contact areas) than the tests, and also should be nonoverlapping and cover the entire domain in order to have the best reconstruction. This, however, may not be the best choice from the practical point of view because the size of the data and/or hardware limitations. Note that this method merely requires measurements (observations). This implies the system can be looked at as a black box, for which a limited knowledge may be available. This offers an experimental approach to this problem; in cases that computing reference measurements is difficult, the learning theory can be utilized to teach the operator M by training the system by a prior set of reference measurements, which will be henceforth referred to as the training set.

Mathematically, this method is reminiscent of considering the references as bases for a vector space spanned by the training set and then trying to find the projection of an arbitrary measurement in that space. The operator [symbol] can be thought of as a matrix with N columns and infinite rows (experimentally very large, ≈10⁵); i.e., a matrix with the reference measurements as the columns. Further, the reference measurements may not generally be orthogonal (for a weak object, in fact, they can be very close). Let δd(t) be a measurement, and δd(t)=δd^{∥}(t)+δd^{⊥}(t) the orthogonal decomposition of it, where δd^{∥}(t)ϵ [symbol] , δd^{⊥}(t)ϵL²\ [symbol] , and [symbol] =span{δdᵢ(t)}ᵢ₌₁^{N}. The projection operator in terms of the data matrix is [symbol] ( [symbol] ^{†} [symbol] )⁻¹ [symbol] ^{†}, where [symbol] ^{†} is the adjoint of [symbol] . Hence,

δd^{∥}= [symbol] ( [symbol] ^{†} [symbol] )⁻¹ [symbol] ^{†}δd. (6)

Upon projecting an arbitrary measurement onto the training data space, we expand it as a linear combination of the bases P (i.e., the reference measurements). That is to write δd^{∥}(t)=Σᵢ₌₁^{N}θᵢδdᵢ(t)= [symbol] Θ, Θϵ [symbol] ^{N}, Θ= [symbol] θ₁, . . . , θ_{N} [symbol] ^{†},

Combining this with the previous equation gives

Θ=( [symbol] ^{†} [symbol] )⁻¹ [symbol] ^{†}δd, (7)

which is equivalent to solving a least squares problem

$${min}_{Θ ∈ {ℝ}^{N}} \frac{1}{2} {‖ ℳΘ - δ d ‖}_{{L}^{2} ( [ 0 , T ] )}^{2} . \qquad ( 8 )$$

When there exist a number of sources and receivers (say Nₛ and Nᵣ, respectively), the formulation above can be extended to min

$${min}_{Θ ∈ {ℝ}^{N}} \frac{1}{2} {\sum }_{r , s}^{ } {μ}_{r , s} {‖ {ℳ}_{r , s} Θ - δ {d}_{r , s} ‖}_{{L}^{2} ( [ 0 , T ] )}^{2} . \qquad ( 9 )$$

where μᵣ's are the weighting parameters. [symbol] _{r,s} and δd_{r,s} are the data matrix and the measured signal at the r^{th} receiver in response to the s^{th} source. The proposed learning method, upon utilizing the entire reverberant field and longtime data, requires a very limited number of spatial measurements (one or two). Furthermore, since the linear combination is pointwise in time, the entire representation is independent of aliasing in time. Hence, it offers a great flexibility in terms of the sampling requirements in space or time.

As aforementioned, the measurements can be close to one another (in the energy norm) in the training data space. Furthermore, measuring or constructing the perturbation δd generally is not a robust approach, since it should be subtracted from do (the measurement with no field-perturbing objects present in the medium). A more robust alternative is to augment the data space by the base measurement do, with the corresponding projection coefficient θₒ, in which case it results in a new constraint:

$${\sum }_{i = 0}^{N} {θ}_{i} = 1. \qquad ( 10 )$$

The underlying physics motivates to enforce a positivity constraint. This is because of the positive definiteness and stability of the system. The physical interpretation is that the entire system (including the object and medium) either conserves or loses the total wave energy. This, in turn, leads to a positivity constraint: θᵢ≥0; for all i.

Furthermore, when it is believed that the distribution of objects is sparse, the optimization problem can be penalized by a sparsity promoting constraint. This is practically imposed by penalizing the problem through the l₁ norm. However, given the constructed constraints, the overall scheme can be conveniently implemented as

$${min}_{Θ ∈ {ℝ}^{N}} \frac{1}{2} {\sum }_{r , s}^{ } {μ}_{r , s} {‖ {ℳ}_{r , s} Θ - {d}_{r , s} ‖}_{{L}^{2} ( [ 0 , T ] )}^{2} . \qquad ( 11 a )$$

subject to

θᵢ≥0, for all i, (11b)

$$μ {\sum }_{i = 0}^{N} {θ}_{i} = 1. \qquad ( 11 c )$$

μ is a penalty parameter. This variant can improve the success of the localization. However, another more powerful variant can be introduced by reformulating the problem in the image space as opposed to the data space. The space spanned by all possible configurations of Θ is called the image space, denoted by [symbol] . This suggests posing the localization problem as a minimization in the image space with essentially the same constraints as before. That is min

$${min}_{Θ ∈ {ℝ}^{N}} \frac{1}{2} {\sum }_{r , s}^{ } {μ}_{r , s} {‖ Θ - {( {ℳ}_{r , s}^{†} {ℳ}_{r , s} )}^{- 1} {ℳ}_{r , s}^{†} {d}_{r , s} ‖}_{{L}^{2} ( ℐ )}^{2} , \qquad ( 12 a )$$

subject to

θᵢ≥0, for all i, (12b)

$$μ {\sum }_{i = 0}^{N} {θ}_{i} = 1. \qquad ( 12 c )$$

This algorithm can be implemented as a two-step method:

Step (1): Solve the original unconstrained least squares.

$${Θ}_{r , s}^{*} = {arg min}_{{Θ}_{r , s} ∈ {ℝ}^{N}} \frac{1}{2} {‖ {ℳ}_{r , s} {Θ}_{r , s} - {d}_{r , s} ‖}_{{L}^{2} ( [ 0 , T ] )}^{2} . \qquad ( 13 )$$

Step (2): Solve a constrained least squares as follows.

$${min}_{Θ ∈ {ℝ}^{N}} \frac{1}{2} {\sum }_{r , s}^{ } {μ}_{r , s} {‖ Θ - {Θ}_{r , s}^{*} ‖}_{{L}^{2} ( ℐ )}^{2} , \qquad ( 14 a )$$

subject to

θᵢ≥0, for all i, (14b)

$$μ {‖ θ ‖}_{{l}^{1}} = {\sum }_{i = 1}^{N} {θ}_{i}^{*} . \qquad ( 14 c )$$

Note that all the above mentioned processing steps can be implemented using the Fourier transformed data, however other data methods can be implemented. Since the system is band-limited, this would lead to a significant reduction in the computation time, once only the in-band information is utilized in the inversion process. Also, the training set may be constructed using a computational model. However, the computation process may lack robustness, and be cumbersome and intense.

Regarding the robustness of the current invention, imaging systems in bounded domains have a finite bandwidth, which is reminiscent of the quality factor of the system itself or due to the transducers. Whence, only a limited bandwidth of the information is registered. There could generally be two types of noise sources. (1) Additive noise, which appears as high frequency fluctuations with generally a normal probability distribution. This noise can be easily filtered by a basic IIR or FIR filter. (2) Multiplicative noise, which can be viewed as a convolution of a random function with the underlying true response of the system (which will be henceforth referred to as drift). Filtering this type of noise can be challenging. The second type of the noise is to a large extent unknown and uncertain, and cannot be estimated or controlled to the precision required for the inversion process. Many factors can potentially contribute to this noise type, such as temperature, temperature gradient, mechanical noise and uncertainties coming about due to stresses and fatigue in time. This motivates to construct a methodology for a blind estimation and compensation of the drift, which can be applied to adapt a posterior training set to the prior one. Let {d̅ᵢ}ᵢ₌₀^{N}^{ₑ} and {dᵢ}ᵢ₌₀^{N}^{ₑ} be, respectively, the posterior (drift affected) and prior (drift free) training sets. This process may go under different names such as restoration, registration, or deblurring. Suppose [symbol] ᵣ is the operator that maps the prior base (background) measurement (with no objects or perturbations) to the corresponding posterior one. This is an example of a regularized inverse filtering. Now an additive noise term n(t) can also be added to the system, which can be thought of as the difference between the white noise in the prior and posterior data models.

dₒ(t)=( [symbol] ᵣ\tilde{d}ₒ)(t)+n(t). (15)

A Wiener filter attempts to construct [symbol] ᵣ such that the expected value of the energy of the error n(t) is minimized.

$${𝒟}_{r} = {arg min}_{{𝒟}_{r}} {𝔼 [ n ]}^{2} . \qquad ( 16 )$$

This gives

$${𝔻}_{r} ( ω ) = \frac{\overline{( \frac{{e}_{o}}{{{e}^{‵}}_{o}} )} {S}_{dd}}{\vert \frac{{e}_{o}}{{\tilde{e}}_{o}} \vert {S}_{dd} + {S}_{nn}} , \qquad ( 17 )$$

where, S_{dd}, Sₙₙ are the (auto)power spectral densities of the measurement and noise, and, [symbol] ᵣ(ω) is the Fourier kernel of [symbol] ᵣ. (̅⋅̅)̅ is the complex-conjugate of ( ). It can be shown that the Wiener filter is optimal when ϵ=Sₙₙ/S_{dd}.

In practice, upon measuring of the background field, the drift operator is constructed as shown above. Next, an arbitrary measurement that corresponds to an unknown object is mapped to a corresponding prior model using the drift operator:

d(t)=( [symbol] ᵣ\tilde{d})(t). (18)

d(t) can now be used against the prior training library.

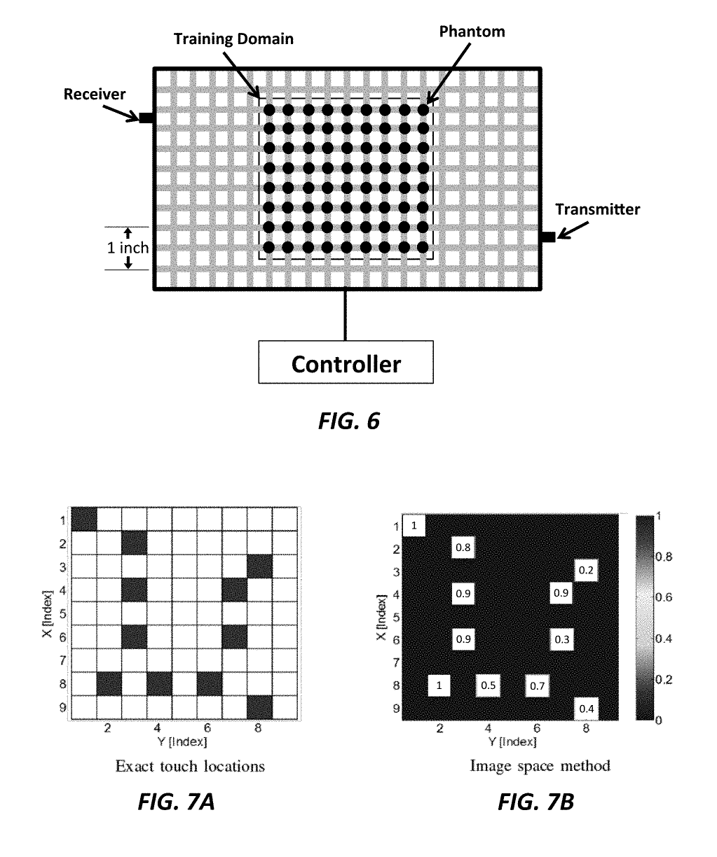

Turning now to the experimental results, FIG. 6 shows a diagram of an in-lab implementation of the explained procedure that was used in the experimental setup. The training procedure includes one transmitter and one receiver. The domain enclosed in the box was chosen as the training domain. A set of grid lines with a half-inch grid-spacing were patterned underneath the glass screen on the Aluminum substrate in order to provide guidance for the training procedure. The screen was then trained on the regions indicated by solid discs, which approximately form a close non-overlapping touch contact areas in the order 0:5 cm² covering the entire training domain. This forms a total of 91 training measurements in addition to the data corresponding to the no-touch case. The system was implemented using a National Instrument™ NI-PXI5024 digitizer, with a 12-bit vertical resolution. A function generator was used to pulse a S0 transducer, with a square pulse with a 630 nsec pulsewidth. The transmitter at the right edge is pulsed using the function generator and the response is measured at the receiver at the opposite edge. The data were acquired at 50 MS/sec corresponding to a 50 MHz sampling frequency and with a 2 msec time-window, resulting in 105 time samples. The localization algorithms were implemented at this sampling frequency.

A natural question arising in the context of any imaging technique is about the resolution limit, identified by the minimum size of a resolvable (identifiable) object. It is essentially diffraction limited and generally in the order a half-wavelength in classical techniques. The answer to this question, however, is more subtle for the proposed learning algorithm, as the entire reverberant field is treated.

A second measure of resolution can be considered as the minimum distance by which an object (e.g., a training basis) can be offset and yet results in a unique identification of the said change. This limit can be well below a wavelength as long as the object size is in the resolvable regime discussed above. This is by virtue of utilizing the entire reverberant field. As long as an object can create sufficient perturbations, through the action of longtime propagation and reverberation, a set of distinct features can be registered that can suffice to distinguish it from its sub-wavelength neighboring locations.

According to the current invention, increasing the number of the touch points does not degrade the performance of the image space algorithm (equations 12a-12c). For a case of eleven-touch tests, the performance of image space algorithm is presented in FIGS. 7A-7B. The image space method relies on a regularization parameter. The effect of this parameter on the location result of the eleven-touch test is shown.

Disclosed herein is a successful design and implementation of an ultrasonic touchscreen system capable of detecting multiple, simultaneous touch contacts, and with a high touch-sensitivity. It demonstrates the benefits of Lamb waves and field reverberation in the screen as the governing mechanism. It relies on the longtime reverberation of the waves inside the screen, where potentially any information induced by a field-perturbing object such as a touch contact interrogates the entire screen several times before reaching out to the receiver(s). The current invention utilizes the minimum number of transducers for a successful localization.

According to other aspects of the invention, adding more transducers can help improve the quality of the localization. It offers a cost-effective technology with a simple hardware architecture. It is sensitive to any touch object that can reflect or absorb ultrasound such as a finger, gloved finger, pen, etc. It is flexible to support a wide range of screen sizes, from a watch to a projection screen. A proper design strategy was presented to achieve a desired performance. The main design features include a proper identification of the lowest order S0 Lamb modes and selective excitation of them upon proper transducer designs. The current invention utilizes a learning method to localize the touch contacts. The chief advantage the algorithm offers is the capability of reducing the number of spatial measurements by virtue of utilizing the temporal information beyond the classical limit, in both coherent and incoherent phases of propagation. The learning algorithm benefits from the entire reverberant field leading, in turn, to merely a single source-receiver pair. The learning method relies on a prior set of measurements and is constructed based on finding the projection of any arbitrary measurement in the space spanned by the prior set. This is particularly important in systems with a limited available knowledge and immense uncertainties. The algorithm calls for the minimum knowledge of the system, and for the most part, looks at it as a black box. Several different improvements of the algorithm were presented based on motivations from the physics or operational conditions of the system. A methodology to compensate for the environmental and thermal noise was also presented, aiming at improving the stability of the learning algorithm. Investigating the stability of the learning algorithm to surface contaminants is the next key step and is left as a future direction.

The presented embodiments are examples of many possible combinations of transducer types and orientations, source-receiver combinations, and frequencies of operation. In practice, the screen is integrated with other components such as different layers of thin films. They can change the effective thickness, material properties, and boundary conditions, which essentially may affect the characteristics of the propagating Lamb waves and the reverberant field. This opens up many directions for the future works to understand how the performance is affected by the said variations and how the system herein can be optimized for the best performance. Furthermore, the system probably is not at the best combination of transducers for the best performance of the localization methods. The perturbed field due to a touch at different locations may not be equal in behavior as (a) the statistical properties of the evolving perturbed modes can be different and (b) the localization algorithms utilize the coherent phase of propagation as well as the incoherent one, and the touch contacts in the vicinity of the direct propagation path between a transmitter-receiver pair create more pronounced perturbations. On-chip implementation of the current system and integration with electronics is yet another important direction for the future works, posing key questions of optimizing the power consumption, amount of memory required for the optimal performance, required frame rate, and so on.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art.

All such variations are considered to be within the scope and spirit of the present invention as defined by the following claims and their legal equivalents.

What is claimed:

1) A method of multi-touch detection implemented on a touchscreen device, comprising:
a) imparting Lamb waves inside a touchscreen, using a first ultrasound transducer, wherein a polarization direction of said first ultrasound transducer is positioned to excite lowest order symmetric Lamb waves (S0);
b) detecting said S0 Lamb waves, using a second ultrasound transducer, wherein said first ultrasound transducer and said second transducer are connected to said touchscreen;
c) controlling said first ultrasound transducer and said second ultrasound transducer, using a controller, to selectively and repeatedly pulse said S0 Lamb waves output from said first ultrasound transducer to propagate said S0 Lamb waves inside said touchscreen and reflect from each edge of said touchscreen, wherein said reflecting S0 Lamb waves form a base signal distribution of S0 reverberant Lamb waves across said touchscreen, wherein a single touch perturbation or a multi-touch perturbation in said base signal distribution of S0 reverberant Lamb waves absorbs a portion of said base signal distribution of S0 reverberant Lamb waves, wherein said absorption forms an alteration in said base signal distribution of S0 reverberant Lamb waves, wherein said alteration is seen as a signal variation by said controller when received by said second ultrasound transducer, wherein said controller identifies and locates said multi-touch perturbation.

2) The method according to claim 1, wherein different signal signatures induced on said base signal distribution of S0 reverberant Lamb waves correspond to different positions of said multi-touches, a number of said multi-touches, and contact areas of said multi-touches, wherein each said signal signature is output as a distinct signal signature by said controller.

3) The method according to claim 1 further comprises a training step, wherein for said first ultrasound transducer and said second ultrasound transducer, said touchscreen is touched using an ultrasound-absorptive phantom over a set of points arranged over a rectangular grid on said touchscreen, wherein corresponding signals are acquired and stored in a memory storage device.

4) The method according to claim 3, wherein said single touch perturbation or said multi-touch perturbation are registered by said controller as column vectors stacked together in a data space Nₜ×N_{c} matrix M, wherein Nₜ is the number of acquired time samples and N_{c} is the number of touch perturbation points, wherein corresponding training waveforms construct a touch perturbation set.

5) The method according to claim 4, wherein said data space is reformulated to an image space by said controller, wherein a localization problem in said data space is transformed to a minimization problem in said image space, wherein solving said minimization problem in said image space comprises solving an unconstrained least squares problem in said data space and solving a constrained least squares problem in said image space.

6) The method according to claim 1, wherein a polarization of said ultrasound transducer comprises a metallization that is parallel to said touchscreen edge.
